(19) United States
(12) Patent Application Publication
(10) Pub. No.: US 2020/0407972 A1
(43) Pub. Date: Dec. 31, 2020

(54) Permeable water-resistive self adhesive underlayment/air barrier building membrane

(71) Applicant: Vaproshield, LLC, Gig Harbor, WA (US)

(72) Inventors: Leland D. Snyder, Gig Harbor, WA (US); Kevin D. Noland, Seattle, WA (US)

(73) Assignee: Vaproshield, LLC, Gig Harbor, WA (US)

(21) Appl. No.: 16/501,888

(22) Filed: Jun. 28, 2019

(51) Int. Cl. E04B 1/62; E04B 1/94; B32B 7/12; B32B 7/06; B32B 27/18; B32B 27/36

(52) U.S. Cl. CPC E04B 1/625; E04B 1/94; B32B 7/12; B32B 7/06; B32B 27/18; B32B 27/36; B32B 2307/7265; B32B 2307/3065; B32B 2307/7246; B32B 2307/71; B32B 2419/06; B32B 2255/10; B32B 2255/26; B32B 2307/732

(57) ABSTRACT

The present invention relates to a water resistant, UV resistant, vapor permeable, air barrier underlayment assembly comprising a substrate of permeable polyester, a permeable copolymer acrylate coating bonded to a permeable polyester substrate and a pressure sensitive permeable copolymer adhesive secured to the permeable acrylate coating. The underlayment is resistant to water and direct ultra-violet (UV) light for a period up to at least one year prior to coverage by cladding.

### RELATED APPLICATIONS

This is an application which claims priority and all benefits from U.S. Provisional Patent Application 62/920,022 filed Apr. 10, 2019.

### STATEMENT REGARDING FEDERALLY SPONSORED RESEARCH OR DEVELOPMENT

None

### REFERENCE TO SEQUENCE LISTING, A TABLE OR A COMPUTER PROGRAM LISTING COMPACT DISC APPENDIX

None.

### BACKGROUND OF THE INVENTION

### 1. Field of Invention

The present invention relates to a building material membrane, and more particularly to a non-asphaltic building self adhered underlayment that is vapor permeable, quick drying, air barrier, and is resistant to water and direct ultra-violet (UV) light for a period up to at least one year prior to coverage by cladding.

An additional feature is the use of the UV resistant black membrane as an architectural shadow element. By using the membrane under an open jointed cladding system a black reveal or shadow is created that can change dramatically the panel reveal design. Alternately, when the black membrane is placed under a perforated panel face design, a shadow area is created under the peroration pattern. Both of these designs ae intended as an architectural element with the membrane being exposed for the life of the building.

### 2. Background of the Invention

In the building industry, an underlayment is typically applied to a wall or roof to form a vapor and air barrier over which insulation and a roof cover is applied. A primary goal of this kind of underlayment is to stop water entry and provide an air barrier. In building construction it is preferable to stop air infiltration and allow water vapor diffusion. The present invention is directed toward providing a building underlayment with increased water hold out, increased UV protection, increased permeability, stoppage of air filtration, while providing high drying capacity and increased fire ratings.

The primary goal of the underlayment is to provide a defense to water entry. Common among the membranes that have the mechanical properties needed to be technologically useful are underlayments such as SBS rubberized asphalt, bitumen asphalt materials or non-permeable polypropylene synthetics.

Other common problems that occur in construction are having the underlayment blow off or tear due to wind or suffer from deterioration because of UV degradation.

Currently, all of the commercial asphaltic and non-asphaltic underlayments tend to be water-resistant but substantially non-breathable or with little or no permeability. That is, both asphaltic and non-asphaltic underlayments do not allow water vapor to pass through it. As a result, the moisture from the interior of the building is trapped and is unable to escape to the exterior atmosphere resulting in damage to the building understructure over the life of the building. Furthermore, present membranes can degrade due to UV radiation from the sun and weather conditions prior to installation of the final cladding. The present building membrane can receive UV radiation directly for a year without deterioration or damage prior to installation of the final cladding and for 20 years behind a properly designed open joint cladding installation.

U.S. Pat. No. 4,511,619 issued Apr. 16, 1985 discloses a sealing sheet for the building industry made up of at least one layer that contains filler such as carbon black mixed with an ethylene-propylene copolymer which has a reinforcing laminate in place. The reinforcing layer can be formed of a fabric, a mat, a knitted material, a non-woven material, a synthetic resin or a glass fiber.

U.S. Patent Application Publication Number 2014/0072751 published Mar. 13, 2014 discloses a single-ply polymer coated substrate with at least one adhesive layer for structural water proofing.

U.S. Pat. No. 8,309,211 issued Nov. 13, 2012 discloses a roofing underlayment substrate that is permeable transmitting water vapor at a minimum of 3 perms, water resistant and skid-resistant. The roofing underlayment includes a woven or non-woven substrate having at least one surface which includes a breathable thermoplastic film which also imparts water-resistant to the substrate.

None of the aforementioned references appear to be permeable enough to allow meaningful transmissions of water vapor nor are they designed to be UV resistant or attempt to prevent or preclude build up of water vapor and the resultant mold, mildew and rot from forming in the roof assembly.

The prior art teachings noted above do not aid in the resolution of a number of practical difficulties that are resolved by the present invention.

Most current research in building envelope design has confirmed that dry characteristics/permeability of a membrane help to eliminate or allow escape of damaging water vapor within the building envelope. However high porosity from large sized pores can also lead to a reduction in water resistance of a membrane, which is not desired. The present invention has a majority of small sized pores with an average size ranging from about 2.0 to about 3.0, preferably about 2.5 microns with about one pore per 50 to 75 square microns. This drying effect of high permeance and the fact that the product is an air barrier, allow for energy savings and offer the desired product characteristics that do not presently exist together in the WRBAB membrane industry.

In view of the drawbacks mentioned above with prior art underlayments, there is a need for providing a non-asphaltic self adhering roofing underlayment that is water resistant while providing a breathable air barrier thereby allowing moisture in the form of water vapor to escape from inside the building assembly, while preventing water vapor moisture from destroying the insulation and structural components. Furthermore an underlayment having durability and long term UV-resistance are highly desirable properties in building construction.

### SUMMARY OF THE INVENTION

The present invention is directed towards a self-adhering underlayment that is water resistive, an air barrier, UV resistant and a vapor permeable. The present underlayment is a multi-layer spun-bond polyester center substrate which is coated on both sides with a permeable foamed copolymer. The coating is a foamed butyl acrylate copolymer containing carbon black ranging from about 2% to about 5% by weight of the coating. A single side of the coated substrate is coated with a separate pressure sensitive adhesive coating, all of the coatings being heated and cured to maintain air bubble pores in place. The permeable pressure sensitive copolymer adhesive coating has a back bone of butyl acrylate, 2-ethylhexyl acrylate and vinyl acetate is foamed and coated over the butyl acrylate copolymer coating bonding to the coating with a reduction in tackiness in the adhesive which may eliminate the need for a slip sheet in some usages. After curing, the pressure sensitive adhesive, back coating and substrate coating can be optionally laminated.

In an alternative embodiment, the permeable polyester substrate has a permeable acrylate coating on both sides of the base acrylic substrate and a permeable pressure sensitive adhesive is applied in spots over one side of the permeable acrylate coating.

### BRIEF DESCRIPTION OF THE DRAWINGS

The present invention will be described with reference to the appended Figures, in which:

FIG. 1 is a schematic enlarged cross sectional view of the inventive underlayment used on a typical construction; and

FIG. 2 is a back plan view of an alternate embodiment of the underlayment without the liner of pressure sensitive adhesive of FIG. 1 but with spot adhesive applied.

These and other objects, advantages, and novel features of the present invention will become apparent when considered with the teachings contained in the detailed disclosure along with the accompanying drawings.

### DESCRIPTION OF THE INVENTION

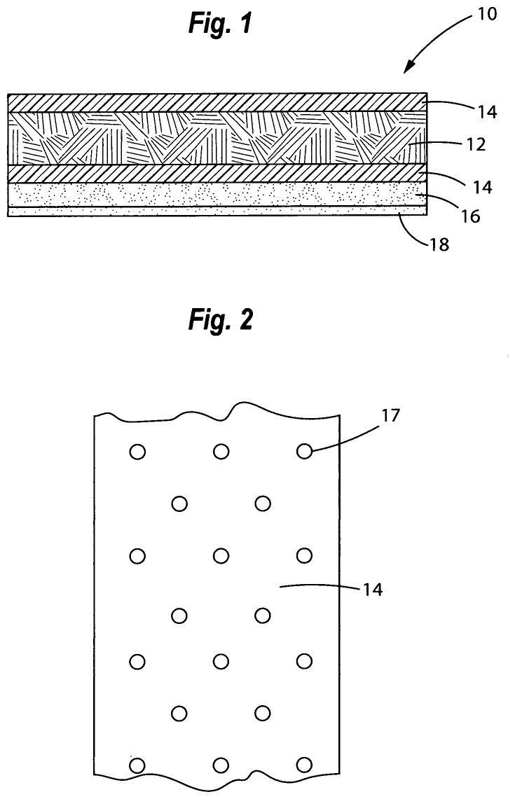

The present invention is directed toward a self-adhering water-resistant vapor permeable underlayment membrane 10 as shown in FIG. 1 which can be successfully used to cover building roofs and walls. The self-adhering underlayment which is a UV stabilized, vapor permeable, water resistant, air barrier and is also rot and tear resistant. With vapor permeance ranging from about 55 perms to about 75 perms, most preferably about 60 perms to 65 perms the underlayment polyester membrane 10 allows the building to breathe or “dry out” as necessary during the seasonal changes. This helps to reduce or eliminate conditions that are conducive to mold, mildew, lumber distortion, insulation deterioration and metal corrosion. The drying aspect is of utmost importance in maintaining building energy efficiency.

The present inventive underlayment 10 is constructed with a center sheet section comprising a plurality of layered permeable spun bond fibrous polyester sheets of material which form a polyester central section 12 ranging from about 10 mils to about 14 mils in thickness with a permeability ranging from about 60 perms to about 80 perms with a preferred permeability of about 70 perms. The polyester sheets or layers are preformed into a single linear sheet 12 and packaged in rolls which are unrolled at the manufacturing facility. The sheets of polyester which form the substrate 12 of the underlayment 10 are preferably multi ply but can have a single thickness. The polyester center section 12 is coated on both sides with an acrylic copolymer coating 14. This water based coating 14 can be applied by dipping the polyester substrate 12 in a foamed bath of copolymer butyl acrylate or alternately coated with a permeable butyl acrylate copolymer 14 by a knife over roller in the coating stage.

The acrylate copolymer coating 14 is mixed with water prior to application on the polyester central sheet section or substrate 12 and run through a foamer (high speed dispersion mixer) so that the coating formed with encapsulated air bubbles ranging in frequency at 1 pore per 50-80 square microns with a majority of the pores having a size ranging from about 1.0 to about 3.0 microns. These air bubbles become interconnected in the acrylate copolymer to form a vapor permeable coating ranging from about 3 mils to about 5 mils in thickness when a bath application or knife coating is used with a permeability of the acrylate central section ranging from about 60 perms to about 80 perms. The polyester center section 12 has previously been formed in sheet form, is rolled and is dispensed from a roll during the manufacturing process. The coating 14 can also be coated on both sides of the polyester central section or substrate 12 in a wet application and is passed through a heater to set the pores in the material so that a vapor permeable coating is formed ranging from about 3 mils to about 5 mils in thickness. The coating 14 is a wet foamed copolymer with the primary polymer being butyl acrylate mixed with polyethylene terephthalate (PET), or a copolymer of PET or another acrylic polymer. Other polymers which can be mixed with the butyl acrylate are methyl acrylate, methyl methacrylate and methyl acrylic acid.

Acrylates are the salts, esters and conjugate bases of acrylic acid and its derivatives. Acrylates contain vinyl groups; that is two carbon atoms double bonded to each other, directly attached to the carbonyl carbon which provide superior bonding.

Carbon black in solution in the amount of approximately 2% to about 5% by weight of the copolymer coating solution is preferably added to the coating 14 for UV protection. This provides long term UV resistance allowing a 12 month direct exposure to the sun. A suitable copolymer base coating is manufactured by BASF SE Corporation and sold under the trademark ACRONAL® 4250.

The butyl acrylate polymer in the coating 14 ranges from 20 to 55% solids, with a pH ranging 7.7 to 8.0. The viscosity can effectively range from 100 to 500 depending on the percentage of solids. Preferably about 20% to about 40% water by weight is added to the coating solution along with a surfactant of about 2.5% to about 3.0 by weight and a foaming agent ranging from 1.5% to about 2.0% by weight. As previously noted, carbon black is also added to the copolymer to reduce tackiness, add strength and increase the UV effectiveness of the underlayment. The copolymer coating material is foamed with the high speed dispersion mixer at 700 rpm with air injection and to entrain air bubbles so that the coating has a foam density ranging from about 50% to about 70% preferably from about 60% to about 70%. The coating 14 is applied to both sides of the polyester substrate 12.

The coating 14 is then heat cured after leaving the coating blade or bath setting the foamed air bubbles in place in the copolymer providing the coating with permeability. The coating 14 pre-dominate polymer ranges from about 30% to about 98% butyl acrylate. The coating can be made fire resistant by adding about 4% to about 6% barium sulfate, preferably 5% barium to the copolymer mixture.

A copolymer acrylic pressure sensitive adhesive 16 is run through a second foam apparatus (high speed dispersion mixer) so that it is formed with encapsulated air bubbles and is then applied to the cured acrylate copolymer coating 14 or to a silicone slip sheet 18 at a thickness ranging from about 3 mils to about 10 mils, preferably about 4 mils to about 6 mils by a second blade coater, and heat cured as previously noted to fix the air bubbles in place.

When the pressure sensitive adhesive is applied directly to the slip sheet 18, suitable pressure can be applied to laminate the polyester central section 12, the acrylate coating 14, the pressure sensitive adhesive 16 and a slip sheet 18. The adhesive 16 fully bonds to the coating 14 for ease of installation and requires no primer. As seen in FIG. 2 the adhesive can be spot applied 17 to the coating 14 for certain usages and the coating 14 is not fully covered by the adhesive 16.

The present underlayment provides a fully self adhered product contrary to present products present in the industry with no need for a primer while remaining very permeable. The present underlayment eliminates mechanical fasteners thereby saving on labor costs, decreasing the probability of leaks and creation of a thermal loss along with preventing discontinuous wind loading. The present inventive underlayment has a direct UV resistance of at least 12 months under direct sunlight.

The copolymer portion of the pressure sensitive adhesive (PSA) 16 has a backbone consisting of n-butyl acrylate, 2-ethylhexyl acrylate, and vinyl acetate.

The pressure sensitive adhesive (PSA) is in the form of a water based acrylic solution. The polymeric portion of the PSA makes up about 90% to at least about 95% of the adhesive formulation and has a copolymer backbone of n-butyl acrylate (about 50% to about 60% by weight), 2-ethylhexyl acrylate (about 32% by weight) and vinyl acetate (about 7% by weight) forming a copolymer blend capable of bonding and crosslinking with the coating 14. Proper foaming of the adhesive is critical to good micropore formation. The aeration process includes high sheer mixing to entrain air in the mixed adhesive liquid solution. This is the same aeration process used for the coating. The self-adhering adhesive 16 is evenly applied on the n-butyl acrylate coating, cured and the micropores are formed and fixed throughout the PSA. The coating method used with the present invention for both the coating 14 and the PVA 16 was accomplished with a blade coater. This is a non-contact coating method and it does not crush or destroy the foam in the copolymer during coating. After application, the adhesive must be heated to lock-in the micropore formation. The adhesive in the present invention was reformulated by adding surfactants and water to the copolymer to control bubble size, bubble density, viscosity, and stability of the copolymer. The peel value of the adhesive is enhanced by the introduction of voids (air bubbles) and the addition of carbon black and a surfactant such as long chain alcohols create a stable inverse emulsion.

The pressure sensitive adhesive 16 is preferably applied to a silicone release film 18 and both are then laminated to the permeable polyester sheet and coating composite. Alternatively the slip release film 18 can be applied the pressure sensitive adhesive 16 after the pressure sensitive adhesive 16 has been coated on the acrylic copolymer coating 14.

The pores formed in the pressure sensitive adhesive are generally round and oval in shape and are larger than the pores in the coating copolymer to form a vapor pathway through the adhesive layer 16. The majority of the pores formed by the bubbles appear to be distributed evenly across the surface penetrating through the adhesive layer when the polymer mixture is heat treated to set the pores in the adhesive. Preferably, the density of the foamed adhesive should fall between about 0.65 and about 0.75 after aeration.

The adhesive copolymer which was used in the inventive underlayment has a polymeric portion ranging from 90% to 98%, preferably 95% to about 50% by weight, preferably about 50% by weight of an n-butyl acetate. The adhesive copolymer was mixed with a first solvent-free, surfactant-based wetting agent, preferably ranging from about 4% by weight to about 6% by weight, and most preferably about 5% by weight to provide emulsification and bubble size; and a second surfactant such as a foaming agent ranging from about 1.5% by weight to about 2.0% by weight, and preferably about 1.7% by weight to provide foam formation. A polymeric based thickener was added to the mixture in a range from about 0.2% by weight to about 0.4% by weight, preferably about 0.30% by weight. The adhesive copolymer composition was added to water ranging from about 40% by weight to about 50% by weight, preferably about 43% by weight to about 45% by weight and mixed in a high speed dispersion mixer at 500 rpm to form uniform bubbles in the mixture and fed into a coater feeder as previously described. The foamed adhesive was coated onto the cured porous butyl acrylate coating and heat cured to form the pores in place in the copolymer.

For industry testing standards, the present underlayment 10 will support a water column of twenty four (24) inches of water for five (5) hours. The inventive underlayment 10 has very high fire resistant properties with low smoke development and flame spread of 0 under ASTM E84 Standard which is the test method for surface burning characteristics of building materials. Thus the coating is NFPA 285 compliant when the barium sulfate has been added into the copolymer solution.

Construction of one embodiment of the inventive underlayment membrane is shown in FIG. 1. An alternate embodiment is shown in FIG. 2.

The principles, preferred embodiments and modes of operation of the present invention have been described in the foregoing specification. However, the invention should not be construed as limited to the particular embodiments which have been described above. Instead, the embodiments described here should be regarded as illustrative rather than restrictive. Variations and changes may be made by others without departing from the scope of the present invention as defined by the following claims:

What is claimed is:

1. A self-adhering vapor permeable, water resistive, air barrier, UV resistant building underlayment comprising a central linear structure of permeable polyester, a coating of a permeable copolymer having a principal polymer of acrylate, carbon black and water, which is coated and secured to both sides of said permeable polyester structure, and a permeable pressure sensitive adhesive coated on one side of said coating of a permeable copolymer.

2. A self-adhering vapor permeable, water resistive, air barrier, IJV resistant building underlayment as claimed in claim 1 wherein said underlayment is permeable and ranges in permeability from about 65 perms to about 75 perms.

3. A self-adhering vapor permeable, water resistive, air barrier, UV resistant building underlayment as claimed in claim 1 wherein said pressure sensitive adhesive is placed on a silicon slip sheet and said slip sheet and pressure sensitive adhesive are laminated to said coating.

4. A self-adhering vapor permeable, water resistive, air barrier, UV resistant building underlayment as claimed in claim 1 wherein said coating contains butyl acrylate with a solids weight ranging from about 15% to about 70% of said coating.

5. A self-adhering vapor permeable, water resistive, air barrier, UV resistant building underlayment as claimed in claim 4 wherein said butyl acrylic copolymer coating when heat cured has a thickness ranging from about 3 mils to about 5 mils, and a barium sulfate filler of about 5% to about 7% by weight of the coating when cured.

6. A self-adhering vapor permeable, water resistive, air barrier, UV resistant building underlayment as claimed in claim 1 wherein said coating is a butyl acrylate and PET copolymer

7. A self-adhering vapor permeable, water resistive, air barrier, UV resistant building underlayment as claimed in claim 1 wherein said permeable pressure sensitive adhesive is solvent free and said coating bonds with said pressure sensitive adhesive to form a stronger bond than said pressure sensitive adhesive would if it were to bond directly to said substrate of polyester.

8. A self-adhering water resistant, vapor permeable, air barrier UV resistant building underlayment as claimed in claim 1 wherein said permeable copolymer central section is a layered polyester and said copolymer coating includes butyl acrylate and polyethylene terephthalate (PET).

9. A self-adhering water resistant, vapor permeable, air barrier, UV resistant building underlayment as claimed in claim 1 wherein said copolymer coating on said center polyester member contains a barium sulfate filler and carbon black, said permeable pressure sensitive adhesive, said coating and said polyester central section ranges in thickness from about 19 mils to about 26 mils.

10. A self-adhering water resistant, vapor permeable, air barrier, UV resistant, building underlayment for buildings as claimed in claim 1 wherein said copolymer coating contains about 3% to about 5% carbon black by weight of the coating.

11. A water resistant, vapor permeable, air barrier, UV resistant, self-adhering building underlayment comprising a base linear sheet of permeable polyester, a permeable acrylate coating applied to said sheet of permeable polyester, and a pressure sensitive permeable layer of acrylate adhesive applied to said permeable acrylate coating, said permeable acrylate coating having a thickness ranging from about 3 mils to about 5 mils which bonds with said polyester central section, said roofing underlayment having a permeability ranging from about 60 perms to about 70 perms and being fire retardant.

12. A self-adhering vapor permeable, water resistive, air barrier, UV resistant building underlayment as claimed in claim 11 wherein said pressure sensitive adhesive is placed on a silicon slip sheet and said slip sheet and pressure sensitive adhesive are laminated to said acrylate coating.

13. A water resistant, vapor permeable, air barrier self-adhering building underlayment of claim 11 wherein said permeable acrylic coating has air bubble pores ranging in size from about 1.0 microns to about 3.0 microns with a dispersion in said acrylate coating of one pore per 50 to 70 square microns.

14. A water resistant, vapor permeable, air barrier self-adhering building underlayment of claim 11 wherein fire retardant material is present in said acrylate coating, said fire resistant material being barium sulfate.

15. A water resistant, vapor permeable, air barrier self-adhering building underlayment of claim 11 wherein said permeable pressure sensitive adhesive has a removable silicon release film mounted thereto to form an exterior surface of said building underlayment.

16. A water resistant, vapor permeable, air barrier self-adhering building underlayment of claim 14 wherein said barium sulfate is present in a range of about 4% to about 6% by weight of said acrylate coating.

17. A water resistant, vapor permeable, air barrier self-adhering building underlayment of claim 11 wherein said acrylate copolymer coating contains butyl acrylate having a solid weight ranging from about 20% to about 55% by weight of said coating.

18. A water resistant, UV resistant, vapor permeable, air barrier self-adhering building underlayment comprising a substrate of vapor permeable polyester, a vapor permeable acrylate coating bonded to said permeable polyester substrate, said permeable acrylate coating being a copolymer including a polymer of butyl acrylate and containing carbon black and barium sulfate with a pore dispersal of about one pore per about 50 to about 75 microns square with a majority of the pores being sized between about 1 to about 3 microns and a vapor permeable pressure sensitive permeable copolymer adhesive secured to an outer side of said acrylate coating, said permeable roofing assembly having a permeability ranging from about 60 perms to about 65 perms.

19. A water resistant, UV resistant, vapor permeable, air barrier self-adhering building underlayment as claimed in claim 18 wherein said coating contains about 4% to about 6% by weight of barium sulphate.

20. A water resistant, UV resistant, vapor permeable, air barrier self-adhering building underlayment as claimed in claim 18 wherein said permeable acrylate coating has a direct UV resistance of up to 12 months.
